(19) United States
(12) Patent Application Publication
(10) Pub. No.: US 2005/0215236 A1
(43) Pub. Date: Sep. 29, 2005

(54) Providing information for mobile users

(76) Inventors: Andreas Myka, Helsinki (FI); Jukka Yrjanainen, Ylojarvi (FI)

Correspondence Address: PERMAN & GREEN, 425 POST ROAD, FAIRFIELD, CT, 06824, US

(21) Appl. No.: 10/502,258

(22) PCT Filed: Mar. 28, 2002
(86) PCT No.: PCT/FI02/00275

§ 371 Date: May 13, 2005

(51) Int. Cl. H04Q 7/20

(52) U.S. Cl. 455/414.1; 455/426.1

(57) ABSTRACT

The invention relates to a method and system for delivering the archived personal content of mobile users and/or material selected on the basis of the archived personal content. At least one remote data repository is connected to the telecommunications system, storing therein information including personal content including data objects and/or information extracted from the objects. At least one of the repositories is assigned for each mobile terminal. Further, external data is stored somewhere in the network. Items of data are retrieved from the remote data repository, the items including an object and/or information extracted from an object. Then at least one predetermined criterion is read, the criterion defining a relationship between the retrieved data and the external data. If the relationship fulfills a predetermined condition, data to be delivered to the mobile terminal is selected and then delivered to the mobile terminal.

### FIELD OF THE INVENTION

The invention relates generally to access to content in the context of a mobile communications system. More specifically, the invention relates to a method and system for delivering the archived personal content of mobile users and/or material selected on the basis of said archived personal content, in the most flexible and personalized ways. Personal content refers here to any personal multimedia data, including e-mail, text messages, images, audio files, calendar entries, log information, and e-commerce data.

### BACKGROUND OF THE INVENTION

The strong growth in the number of Internet users and services provided through the Internet has been one of the most remarkable phenomena in communications in recent years. Another current trend is the strongly increasing use of various mobile terminals, such as laptops, PDA (Personal Digital Assistant) equipment, and intelligent telephones.

These two rapidly evolving network technologies, wireless communication and the Internet, are gradually converging. So far this converging development has been progressing rather slowly, since most of the technology developed for the Internet has been designed for desktop computers and medium or high bandwidth data connections. It has, therefore, been difficult to introduce IP-based (IP=Internet Protocol) packet services to the mobile environment, which in comparison to fixed networks is characterized by less bandwidth and poorer connection stability, and with terminals having many fundamental limitations, such as smaller displays, less memory, and less powerful CPUs than fixed terminals. However, the development of IP-based packet services for the mobile environment will occur at an increasing rate in the foreseeable future. This is partly due to the demand created by the market and to the evolvement of new technologies designed to meet the various requirements of mobile networks, such as sufficient quality of service and data security. The increasing market demand is based on the rapid increase in the popularity of the Internet: Internet users are often also mobile subscribers and thus may also want to use at their mobile terminals the services familiar to them from the Internet environment. This commercial demand in turn enables investments necessary for the development of mobile services. Examples of said new technologies are GPRS (General Packet Radio Service) and WAP (Wireless Application Protocol). GPRS aims at providing high-quality services for GSM subscribers by efficiently utilizing the GSM infrastructure and protocols. WAP, in turn, defines a set of standard components enabling communication between mobile terminals and servers to provide services available in the network. WAP utilizes proxies that connect the wireless domain with the World Wide Web domain.

The above-described development will in the near future turn the mobile terminals into versatile multimedia tools. In addition to the features that current mobile terminals include, these future terminals will have a variety of sensors for multimedia data, for example, a camera and a location sensor. Besides the technical feasibility of constructing such devices, it is important that the users get a clear benefit from using such terminals and that the telecommunications system to which the terminals belong does not pose restrictions on the efficient use of the devices.

In comparison to already existing multimedia tools, such as digital cameras, the recent development of mobile terminals can offer a variety of new multimedia related services, as the technological solutions used by the mobile terminals and the mobile network infrastructure enable various possibilities not seen before. On the other hand, the interconnected networks, such as the Internet, act as enabling factors as well. The possibilities thus created have so far mostly been unexplored, leaving space for innovative practices and new service models within the communications industry.

One example of the immense possibilities mentioned above is sometimes referred to with the general term “metadata”. Metadata itself is data about data, defining new relations inside a batch of data and building new ontological layers. The existing solutions for deploying metadata by no means effectively utilize all the many possibilities offered via mobile terminals. Some prior art examples of using metadata are described in more detail in U.S. Pat. No. 6,282,362 and European patent application 1 004 967. Typically, images are an important part of multimedia information, whereby metadata may include the location where an image was taken or information describing the subject of an image, for example.

As an example of the “Universal information appliance” (in IBM Systems Journal, Vol 38, No 4, 1999) the user is provided with a calendar application. When the user records a new calendar entry, the active calendar service sets out to find the pertinent information and downloads it for the client for display in the calendar application. The calendar system collects information, such as e-mail address, a cellular phone number, and so on, and possibly some company news of the party to be met. The collected information is downloaded through a network and over the wireless link to be displayed to the user.

However, none of the solutions referred to is capable of offering a total solution for a mobile terminal user with respect to the flexibility of storing, transfering, and using the personal content acquired by the user or the terminal, because all known solutions have been developed from a narrow point of view with the aim of resolving a single problem each time. To a large extent, the demands raised by the users, as well as the possibilities offered by the versatility of the systems used, have not yet been explored.

Whenever data is not available locally, the problem is how to access the data. Thus any access requires time and effort.

The objective of the invention is to introduce a novel concept for providing the users with an enhanced method and system for obtaining information based on the personal data pertaining to a mobile user.

### SUMMARY OF THE INVENTION

The objective of the invention is to accomplish a solution which allows efficient and user-friendly mechanisms for providing information to mobile users in the context of their personal data. This objective is achieved with the solution defined in the independent patent claims. The dependent claims describe some of the preferred embodiments of the invention. The core of the invention is the mechanism of delivering information to the user, the selection of the information to be delivered being at least partially based on the personal content acquired by the user.

According to the invention, personal content is first stored in the mobile terminal. At least one remote data repository connected to the telecommunications system may be used for storing information with personal content including data objects and/or information extracted from said objects. The remote data repository may be provided with an accessor so that the user may access data from at least one terminal. At least one of the repositories may be assigned for the use of each mobile terminal. External data is stored somewhere in the network, and data including an object and/or information extracted from an object is retrieved from the remote data repository.

At least one predetermined criterion defines a relationship between pieces of the retrieved data and pieces of the external data. It is analyzed whether the relationship fulfills a predetermined condition, and in response to the analyzing step, data is selected to be delivered to the mobile terminal when said condition is met. The analyzing step may be performed either in the network, or at the mobile terminal. The former corresponds to a pull mode, the latter to a push mode, respectively.

According to one aspect of the invention, algorithms evaluate the user patterns of access to his or her data. The data is then obtained at the mobile terminal in a predetermined manner defined by the access patterns, and the user obtains the data without delay even though the data is usually located in some remote place. The user perceives no system boundaries, but rather is presented with a virtually unlimited memory. In this way, the data is available for the mobile without delay.

### BRIEF DESCRIPTION OF THE DRAWINGS

The invention is described more closely with reference to FIG. 2-12 of the accompanying drawings, in which

FIG. 1 illustrates a mobile network wherein prior art services are provided to the users,

FIG. 2 is a schematic diagram of a system which can be used to provide enhanced data storage capabilities according to the invention, the diagram describing network elements favorable when implementing some embodiments of the invention,

FIG. 3A shows sample content of a software block of a user terminal 100 which can perform some tasks described in a preferred embodiment,

FIG. 3B illustrates the hardware block of a user terminal 100,

FIG. 3C illustrates the contents of the storage means of a user terminal 100,

FIG. 4A illustrates the functional blocks of the software in the MD DB server 240,

FIG. 4B represents the contents of an exemplary remote data repository 242,

FIG. 5A is an example of the functional blocks of the download registry 280,

FIG. 5B illustrates the mechanism of how the rule generation and information provision are linked to each other,

FIG. 6 illustrates a rule updating mechanism (61) and another rule evaluating mechanism (62) according to the first preferred embodiment of the invention utilizing a pull-type mechanism,

FIG. 7 illustrates (71) actions launched by a rule evaluator, such as downloading objects (72) and updating of the Media Diary system (73) in the user terminal, according to the first preferred embodiment of the invention,

FIG. 8 illustrates two logical parts of the second preferred embodiment of the invention, operations (81) after detecting a new object in the application and operations (82) after detecting a new object or a new rule in the server daemon,

FIG. 9 further illustrates the push mode according to the second preferred embodiment of the invention,

FIG. 10 illustrates a case with a fixed rule with one parameter,

FIG. 11 illustrates a meta rule, and

FIG. 12 illustrates a case where a rule has been made by a meta rule.

### DETAILED DESCRIPTION OF THE INVENTION

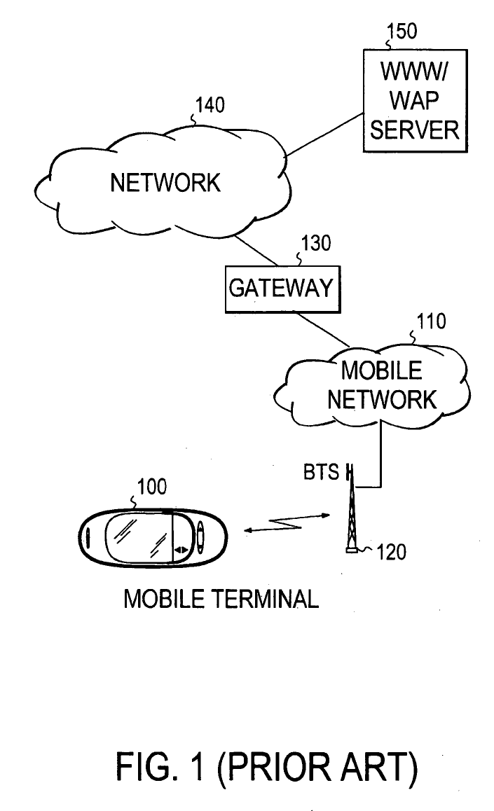

FIG. 1 shows a schematic diagram of a prior art system for providing services to mobile users. A mobile network 110 is connected via a gateway element 130 to a communications network 140, such as the Internet. These kinds of arrangements are widely used to provide services to user terminals, of which one mobile terminal 100 is illustrated in the figure. Mainly, the terminals are connected with the mobile network via base transceiver stations (BTS), of which only one BTS 120 is illustrated in FIG. 1. The BTS in plurality form a radio access network for the network 110.

Many services provided to users are produced in different servers, of which only one WWW/WAP server 150 is illustrated in FIG. 1. The servers 150 are mostly connected directly to the Internet and provide many different services, such as following the stock exchange rates applying criteria supplied by the user subscribing to the service in question. When the server detects that some criterion is fulfilled, it notifies the user by sending a message. Further, services such as directory services or anonymous chat services may be implemented using a server system similar to the example above.

According to some aspects of the present invention, rules are generated from access patterns. The access patterns describe the manner (e.g. frequency, occasion) in which a specific user uses either personal data (such as objects) or data from an external database, such as bus or train timetables.

The access patterns can be generated using some techniques known in the art, such as pattern recognition, using some detailed models in which the access to data may be modelled. Typically, this can be implemented using means of fuzzy logic programming, where some action is launched when the correlation between the action and the model seems to be clear enough. Other means include proximity values, boolean logic truth values, probabilistic models, and so on.

The generated rules may be evaluated. When a predetermined condition is fulfilled, such as the remaining time to a scheduled meeting or a distance to a specific point in space, the action defined by the rule is then performed. The action may be, for example, delivering to the user personal content or data defined by the rules. The delivery process may be initiated by the mobile terminal (pull mode) or by a server in the network (push mode).

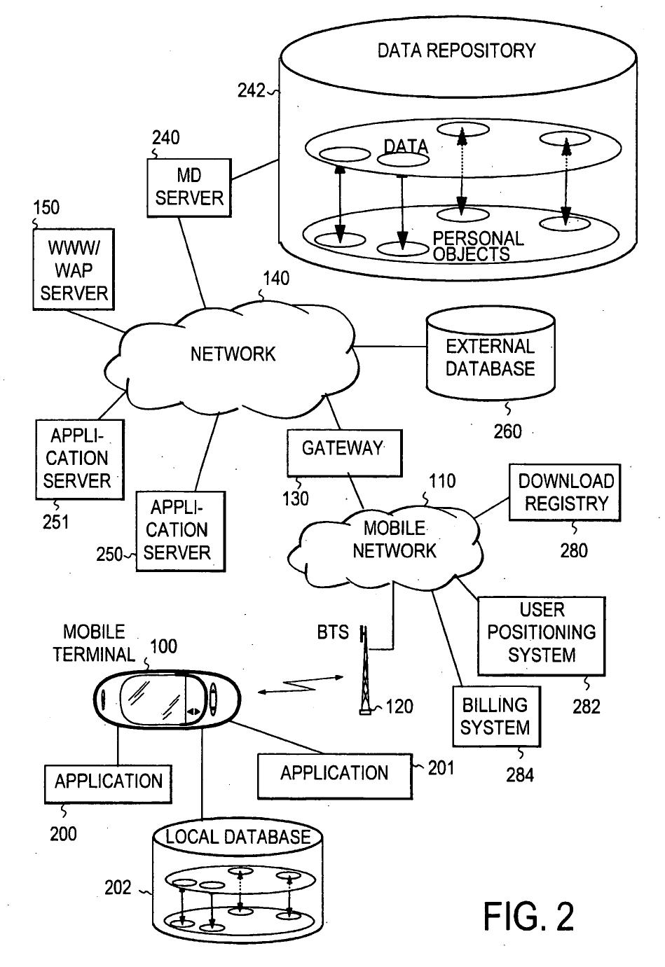

FIG. 2 shows some aspects critical for designing a network architecture in view of the recent development trends. Because the mobile terminals have been evolving towards versatile multimedia tools, they are equipped with some preinstalled applications. Examples of typical applications are a camera user interface and personal information management (PIM) applications, such as calendar and contact management application and data storage logic, which can also be implemented in a software application to facilitate the possibilities offered by the terminal hardware. The application data forming personal content is stored in a local database 202, which can in practice be a memory chip or a local disk drive. These are commonly understood to be hardware parts, but normally the database comprises both hardware and software as discussed below. The idea is to implement the system using different functional parts in order to provide the user with a reliable means for storing information. According to the invention, the mobile terminal 100 is provided with a plurality of applications, of which two examples 200 and 201 are presented in FIG. 2. Applications typically have an accessor which includes means to access the content and to read data from data storage. Some applications may also include an analyzator, which is usually arranged to include means with which to perform simple analytic tasks or to transfer the content to a remote data repository 242. Further, the system comprises a Media Diary (MD) server 240. The MD server is provided with several functionalities, not only controlling the access to the remote data repository, i.e. the MD database (DB), but performing other tasks quite like a user would carry out using a traditional diary and notebook. Basically, in the terminology used further in this description, the term Media Diary defines the concept of collecting personal content acquired by the user, further refining it, and then using it in generating services. In other words, the Media Diary is a multimedia equivalent to a traditional diary in which the user may collect photos, memos, and other practical stuff which, when combined with the possibilities of the digital world, are used in producing services.

Further, the system comprises a plurality of different application servers 250 and 251. It is to be noted that the servers need not be separate elements, but that in some cases the applications may be stored in the MD server as well. The same applies to the remote data repository 242, which can be included in the MD server 240. According to one aspect of the present invention, the different elements together with their functionalities comprise an MD system which includes a terminal, a server, a data repository, and means to execute some applications stored somewhere in the network. The purpose of the MD system is to provide the user with reliable data storage on the one hand, and on the other hand, with a possibility to easily gain the advantage of personalized services. A remote data repository may thus contain objects that form the personal content, metadata extracted from said objects and retrieved from other sources, and other data retrieved from other sources. This system includes accessors which may have centralized and/or distributed means for accessing the personal content from the mobile station or from another terminal which the user prefers to use. Usually the means are implemented by using communications elements responsive to each other, or in other words, a group of distributed communication peer entities, and controlling access as necessary for data security.

The system has access, if necessary, to one or several external databases 260. This can easily be implemented using the Internet or some other communications network.

The user data is transferred from the local database 202 to the data repository 242. For the downloading task an download registry 280 may be involved. Typically, modern mobile networks also include other practical means, such as a user positioning system 282 and a billing system 284. Some components, such as a positioning system 282 or an external database 260, are already known from prior art, but they are presented here with reference to FIG. 2 because some aspects of the present invention enhance the use of these systems in the manner described below.

The conceptual difference between external data storage 260 and a remote data repository 242, as used here, is not a physical one, but a logical one. The remote data repository is dedicated for storing personal content of mobile users, such as personal content objects and data extracted from them, and for storing data which forms some personalized services. The external data storage is basically used for storing data which is not necessarily personal but fetched from other sources, such as the Internet or a newspaper. The data retrieved from the external data storage may be further analyzed or handled, and the results may be stored in the remote data repository. As a part of the conceptual realization of the MD system, the remote data repository provides a remote safe deposit box for the personal data of the user.

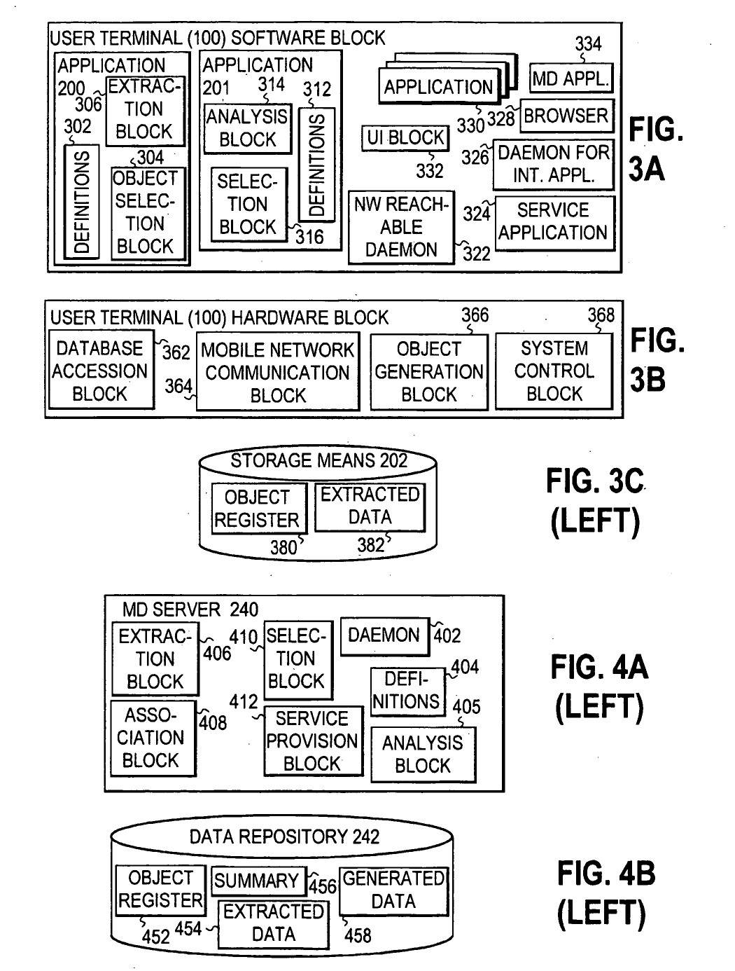

FIG. 3A is a schematic diagram of a software block of the user terminal 100. Application 200, which can be used to extract data from an object, includes definitions 302 that define some settings, such as which kind of objects the application is capable of working on, then possibly some adjustable parameters, such as the resolution settings for digital images, and so on.

Application 201 comprises in addition to definitions 312 an analyzator, such as analysis block 314, and then a selector, such as selection block 316. Application 201 may be used, for example, for inquiring about the terminal data storage status and then selecting files to be deleted if necessary. The Analyzator and selector may be implemented using a normal computer executable code, so that the corresponding blocks correspond to a piece of software and include software-executable means for performing the tasks intended.

The mobile terminal may comprise a plurality of other applications 330 as well, in addition or instead of applications 200 and 201. The mobile terminal usually also contains some form of user interface UI block 332. According to one aspect of the present invention, the user terminal may have a Media Diary MD application 334 as well. Typically, some mobile terminals also comprise a browser 328. The MD application is intended to convert the user terminal into a versatile multimedia tool capable of providing special services related to the personal content acquired by the user. Such services are various, but in view of the enhanced data storage functionality, basically the services relate to the associating of metadata related to personal content (or data which has been extracted from said personal content) to the personal content itself, extracting information from said content, transfering of content to and from the remote data repository, accessing said stored content, performing some actions like deleting obsolete or outdated information from the user terminal, and so forth. In principle it is one object of the MD application to provide the user with a user interface and means to set-up all the various definitions and with operating models related to these functionalities, which thus act as a sort of front end. Even if the tasks described above are performed by dedicated program applications, some residing in the mobile terminal and some in a networked computer or server, and adapted to be independent in the sense that the special MD application is not necessary, it is under current development work in order to offer the user a single point of control and use.

Further, the user terminal has two different daemons available. The network reachable daemon 322 takes care of connections initiated from the mobile network 110 or some other communications network 140, such as the Internet. The daemon 326 for internal applications acts as a middleman between the hardware and software. It may also monitor the actions of other applications and perform some predetermined tasks-when deemed necessary.

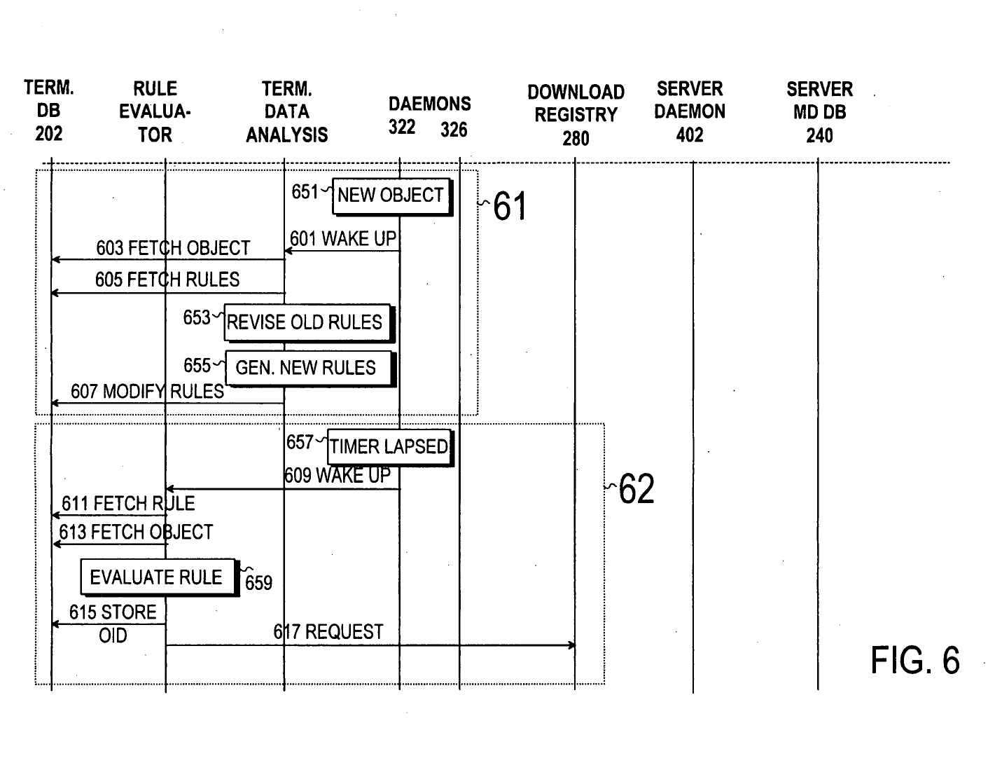

The service application 324 includes a monitor which monitors rules stored in the rule container of the application. Preferably, this data is stored in the terminal database 202 but read into the terminal random access memory. Basically, application 324 follows the status of the object register, so that it receives notification from the daemon 326 when a new object has been generated or an existing object has been modified. This is discussed in detail with reference to FIG. 6 and the dashed box 61. Application 324 also includes a communicator, so that the application may communicate with local data storage 202, the daemon 326, and with applications such as 200 and/or 201, which may actually examine the practical issues related to new objects. From time to time the application 324 communicates some parts of the rules to the daemon 322, which may follow different timers and other criteria specified in the rules.

FIG. 3B is a schematic block diagram of the hardware block of the user terminal. In this context the hardware is considered functionally separate from the storage means 202, but it is to be understood that it is also possible to implement both functionalities together in a hardware block, basically because the physical realization of the storage means always requires some sort of hardware. Usually the functionalities in the hardware are performed by software as well, but because more efficient processing is desired, the software is coded in low-level programming language and stored in a read-only memory. However, this is not to be considered as a limitation, but as one possibility to enable efficient implementation of the invention. The hardware block has a database accession block 362 with means to perform operations on the storage means 202. Then the hardware block has a communicator which is preferably implemented with communications means in the mobile network communication block 364 in order to maintain communication with the mobile network 110 and its base transceiver stations 120. Further, the object generation block 366 can assist in generating personal content objects, be they digital images, calendar entries, speech, or text messages generated by some application or via some part of the hardware. The system control block 368 supervises the system- and keeps the different functional blocks in the hardware running.

FIG. 3C is a simplified block diagram of the local storage 202 of the mobile terminal. First, there is an object register 380 which is intended for storing personal content. Secondly, there is also an extracted data block 382 for extracted data. Typically, such data extraction may be performed in the extractor, which includes an extraction block 306 of some application, for example. The extraction block has data extraction means, such as a code for a piece of software, adapted to extract exposure data from a digital image or data from a calendar entry. Data describing the access patterns may be stored in the extracted data block 382, or in an application providing the service.

FIG. 4A shows a simplified structure of the MD server 240. The server has a daemon 402 to activate the correct service provision block 412. For this, both the daemon 402 and the service provision block 412 have definitions 404 which contain, for example, information on requirements posed by the services and different options for service requests. In order to complement this task, the MD server may also have an extractor, such as data extraction tools in an extraction block 406. Because the user data which forms at least a part of the personal content is stored in the data repository 242, the extracted information must be associated to the corresponding personal content or content object. Therefore, the system also has an associator, such as association tools in the corresponding association block 408. Due to the possibly large number of personal content items, the system may further comprise selection tools in a selection block 410, with the task of selecting the right personal content, either in the form of an object or extracted data, for the provision of the personalized service.

FIG. 4B is a schematic block diagram of the functional blocks of an exemplary remote data repository 242. First of all, the repository contains personal content in the form of objects in the object register 452. The repository may also contain a summary 456 of the content stored in the register. To this content may belong data extracted 454 from the objects and also data generated 458 by some services. It is to be noted that the services may be provided in the service provision block 412 of the MD server in a separate application server 250 and/or 251. The production or provision of services may also be performed in steps in such a way that some parts of the service are generated in one server and some other parts in another. It is clear that the designing of the services gets a bit more complicated when the number of servers involved increases. Finally, the service may be combined from several parts to form the complete personalized service, and the combination can be performed either by some server in the system or at the user terminal. In the latter case the combination of the service from elements may be virtual, so that the user need not be made aware of how the different elements of the service are actually produced. Data describing the access patterns may be stored in the generated data block 458, or in the service application providing the service.

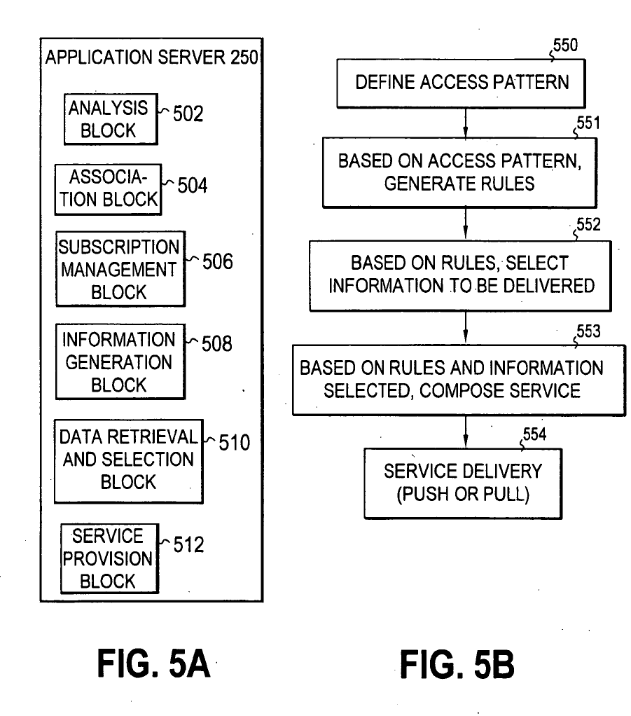

FIG. 5A is a block diagram of an exemplary application server 250. First, the application server receives a request. The request is then analyzed in the analyzer. The analyzer preferably includes an analysis block 502. The analyzed request is then associated with some service or some mode of the service, which may be identified on the basis of the parameters or options in the service request, for example. For this purpose each block in FIG. 5A may have its own definitions if necessary, but in practice there is also one common definition file for the application server. The association is performed in the corresponding association block 504.

In some cases, especially for commercial services, there is a subscription management block 506 in the application server as well. If a service is provided for free, such as for advertising purposes, subscription management may not be necessary. It can, of course, still be used for collecting statistics etc.

The information generation block 508 analyzes the personal content and generates information on the personal content. It may also perform the functions of combining information from different sources, and even combining different parts of the personal content. The personal content is preferably delivered to the service with the service request, as this minimizes the amount of necessary signaling. However, because this is not always the case, the application server also has a data retrieval and selection block 510. This is useful also for retrieving information from other sources, such as web search engines, external web databases, or other connected information systems. Finally, the service provision block 512 has means for providing the service, or at the sub-service level (that is, part of the service) some content to be used for the building of the complete service. The service provision is performed by combining both generated and retrieved information. This information may be further altered or analyzed to better meet the objectives of providing personalized services.

FIG. 5B illustrates one aspect of the inventive mechanism in which the rules are generated based on the access patterns, and the service delivery is launched by the fulfillment of the rules.

First, in step 550 access patterns are defined. The access patterns are models according to which either users in general or a specific user (or user group) utilize or are willing to utilize data. For example, a user normally located in Helsinki, Finland is going to have a business meeting in Munich, Germany. The user is interested in football. The access patterns may be created such that 1) when there is a meeting, an image of the other party is downloaded to the user terminal at a predetermined time before the meeting takes place, 2) when the meeting is in a different town, a map of the town, as well as the local bus and commuter train timetables, are downloaded at least six hours before the departure, and 3) information related to any football events within 50 km from the venue of the meeting is delivered to the user at the time when the meeting is going to end. Similarly, the rules may instruct that the digital images the user took the last time he was visiting the same area (say a circle with a radius of 100 km) are delivered to the mobile terminal before the meeting. These rules may be generated automatically, or they may be programmed manually. The models for access patterns can also be studied by observing a group of users, e.g. by performing a study or monitoring their usage behavior for a short period of time.

In step 551 rules corresponding to access patterns are defined. The rules can also be generated based on other suitable information than access patterns, such as calendar information and/or location information of the mobile user, and especially practical services can be offered when the rules are generated using both methods in combination. The general access patterns are adapted to meet a specific event and/or criteria. Similarly, in step 552 the general patterns describing the items of data, such as personal content or external data, are modified to contain specific criteria for the files to be transferred. This can be understood as selecting the information to be delivered. This may also include associating some metadata with some files, possibly using some analysis means or data extraction, or some other tools.

The exact way for the provision of information is composed in step 553. This may include monitoring the rules defined in step 551. When the rules are fullfilled, the service is delivered in step 554, i.e. information is provided as defined in steps 551-553. In the basic service model, the service is providing information such as the already stored personal content, or other suitable information which may have been fetched from an external database. It is also possible to create advanced service models which include other kinds of operations.

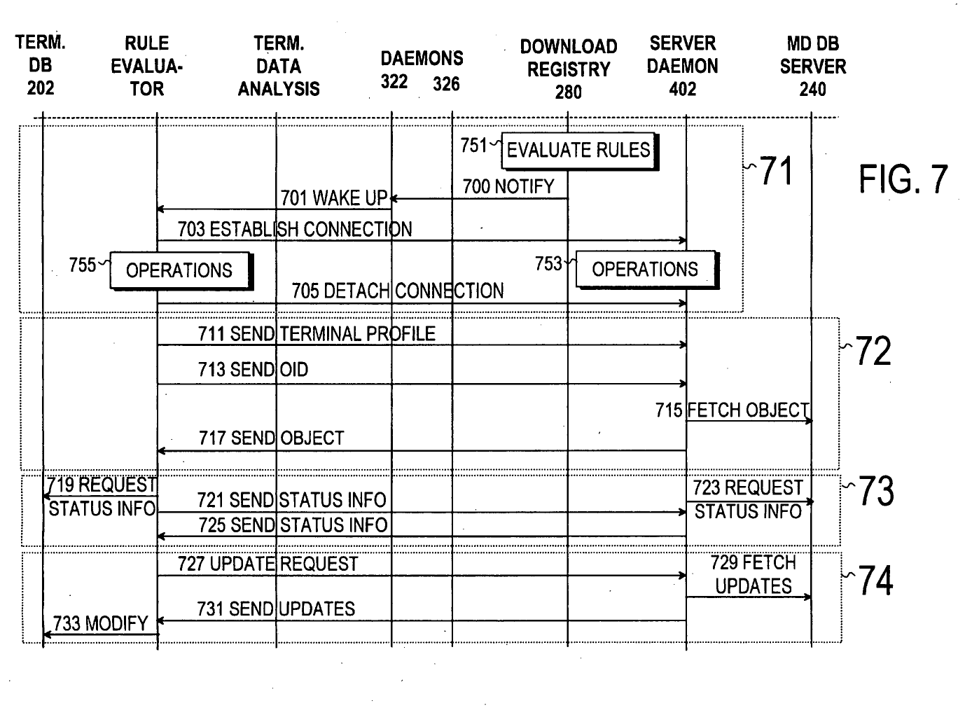

In the following, some aspects related to the implementation of the invention by pull mode are described in more detail in FIGS. 6 and 7.

FIG. 6 shows one aspect related to the rule updating mechanism in the dashed box 61. First, step 550 has already been performed. The box 61 includes messages beneficial for implementing steps 551 and 552. When the new personal content object has been detected in step 651 by the daemon 322, the daemon notifies the terminal data analysis application by sending a message 601. The recipient of this message may be the MD application 334, or some other application in the mobile terminal, such as the application 200 or 201. The terminal data analysis application fetches objects from the terminal database 202, preferably by sending an object request 603, and possibly depending on the kind of the object, by sending a request 605 for rules regarding information delivery. The selection of the rules may be performed based at least partially on the object, thus it is also possible to run the object first through the extractor or the analyzator in the terminal, where functionalities may be located in the applications 200 or 201, respectively.

In step 653 the old rules are revised. If they need to be updated, or if some old rule turns out to be obsolete after the creation of the new object, as might be the case when a vacation is cancelled because the user has scheduled an urgent work-related meeting in the middle of the week in his calendar application. For this reason the scheduled download of the ferry timetables from Helsinki, Finland to Travemünde, Germany might be canceled. Not only the creation of a new object may launch this kind of activity, but also the modification of an existing object, such as a calendar entry, may trigger the same kind of action. If a new object is generated and it is necessary to generate new rules, then the generator creates them in step 655. The generator, as already discussed above, may be located in the service application 324 or in some other suitable location. Finally, the new and/or revised rules are stored in the terminal database when they are sent in a store command 607.

The dashed box 62 illustrates some aspects of the rule evaluator relating to step 553. The rule evaluator executes the defined rules, i.e. checks whether the predefined criteria are fullfilled. In order to deduce this it may use external data, such as time or date information, location systems of the mobile networks, or data from other external databases, such as Internet search engines. When the daemon 322 notes (step 657) that a timer has lapsed, it wakes up the evaluator by sending a wake-up message 609. The rule evaluator may be located in the application 324 or in some other suitable application.

The rule evaluator fetches the rules from the local data storage by sending a request 611 for rules and a request 613 for objects. In other words, the rules and some objects specified by the rules are read into the terminal memory, or if everything is contained in the random access memory part of the terminal, the memory blocks identified by the pointers in the service application 324 are read.

In step 659 the rules are evaluated by the rule evaluator, like the idea of composing the service in step 553. If the result of the evaluation shows that at least one criterion is fulfilled, the corresponding object identity (OID) is registered into the terminal database 202. In practice this may be done so that the rule evaluator sends it in the registration message 615 to the database. The step 659 is repeated until all rules have been scanned through. Then the rule evaluator sends the request 617 for downloading the selected information to the download registry 280. This is part of the service delivery step 554.

In FIG. 7 the dashed box 71 shows the download registry evaluating (step 553) rules in step 751 and also performing step 554. The download registry continuously follows receiving the OIDs if the rule evaluator decides to send them. One task of the download registry is to continuously evaluate the rules, not only on the basis of recently sent OIDs but also based on the data on its own register. When the situation meets some specific criteria, the download registry notifies the terminal daemon 322 by sending a message 700. The daemon 322 gives a wake-up to the rule evaluator, e.g. application 324, by sending the message 700. The rule evaluator establishes a connection (with a connect message 703) to the server daemon 402, which is preferably connected to the MD server 240 like shown in FIG. 4A.

After this, both the rule evaluator and the server daemon perform operations, the latter being denoted by step 753, the former by step 755. After the operations have been performed, the connection is detached by sending a detach message 705.

In the dashed box 72 there is a first set of possible operations 753/755 corresponding to step 554. The rule evaluator sends (message 711) a terminal profile to the server daemon 402. Then it sends OIDs in a message 713. The server daemon fetches (message 715) the objects from the MD DB server, which may be connected to the remote data repository, or the remote data repository may take care of the duties of the MD DB server, such as transformation the objects. Finally, the server daemon 402 sends the object in message 717 to the rule evaluator. In the implementation described herein the object may be passed further to the terminal database.

In the dashed box 73 there is a second set of possible operations 753/755. The rule evaluator requests (message 719) information about the status of the local storage 202. This status information is then sent to the server daemon 402 in a message 721. Similarly, the server daemon may request the status of the MD DB server 240 (or, remote data repository) in message 723 and delivers it (message 725) further to the rule evaluator. In this way the status information in both local storage and remote data storage may be synchronized.

In the dashed box 74 there is a third set of possible operations 753/755 which corresponds to steps 551 and/or 552, i.e. to the situation where some rules, access patterns, or selections have been modified. The rule evaluator may request (message 727) an update from the server daemon 402. Preferably, the request may contain an identifier containing a check sum compiled from the rules in the local storage. If the server daemon notifies that the rules are outdated, after comparing them with the rules stored in the remote repository, the server daemon may request (message 729) updated rules from the MD DB server 240 and send them to the rule evaluator in a message 731. The new rules are stored in local storage 202, possibly after they are compiled into a more applicable format.

The rule evaluator may handle the terminal operations of dashed boxes 72-74, but it is also possible that the operations are distributed into several different applications in the terminal.

According to one aspect of the present invention, the idea of the service described in FIGS. 6 and 7 is that the material can be pulled from the network by the terminal. In this way, the terminal may proactively select information for the user. When a new object is detected either in the terminal or in the remote data repository, the information extracted from the object is compared with the rules. If the comparison shows that a predetermined criterion is met, some information is selected and then retrieved for the user. In this way the personal content can be used for offering the user some value-added information he or she is going to need.

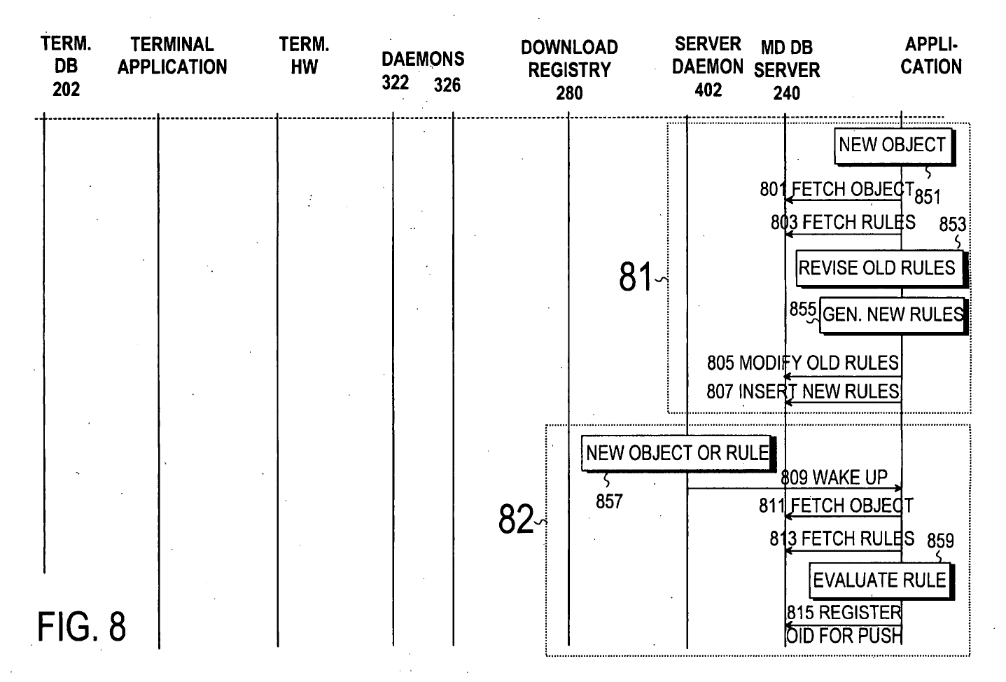

FIG. 8 shows the case when the idea above is reversed so that the value-added information is offered from the network. The dashed box 81 depicts when an application such as 250 or 251 detects a new object (step 851). The new object may be practically anything; on one hand it may be a personal content object that has been run through an analyzer, on the other hand it may be any other object containing some information possibly of interest to the user, such as a new bus timetable. In this example the object is retrieved from the MD DB server 240 (which is in this case connected to the remote repository 242), but in principle it could be fetched from any external database 260. The application then sends a request 801 to the MD DB server to deliver the object stored in the remote repository, and the MD DB server checks the permissions and answers the fetch request. Then the application sends a request 803 to obtain the rules.

In step 853 the old rules are revised and new rules are generated. For example, the object may be a calendar entry that the user is going to have a scheduled meeting on Mar. 28, 2002 with Mr. Samuli Honkanen, who is a local patent agent with whom the user has recently been collaborating. After the scheduling of the next, it was established that both are keen skiers. The rules may be modified so that one day before the meeting the user is supplied with the user's images when he was skiing in Lapland. Because the user is a dedicated skier, he has loads of pictures, so that they cannot be stored for a long time in the terminal's local data storage but only for temporary use. Because of the new rules, the application sends the images with a tag “skiing images” from the external repository to the local data storage when the timer lapses.

Similarly, new rules may be generated in step 855. The modified rules are appended to the MD DB server by sending message 805, and in the same way also the new rules can be delivered in message 807. Whereas new rules are generated, old rules may be revised when there are some amendments to be made.

The dashed box 82 illustrates operations performed after the server daemon notices (step 857) a new object or a new rule. First, the application (250 or 251, for example) is woken up by receiving a message 809. The application fetches the object (message 811) and the rule (message 813) and evaluates the rule in step 857. Then if the rule shows that the object is to be delivered to the mobile terminal, the OID is registered for a push by a message 815 sent to the MD DB server 240.

The messages 801-807 and steps 851-855 correspond to step 551 of the push mode. Similarly, the messages 809-815 and steps 857 and 859 correspond to step 552.

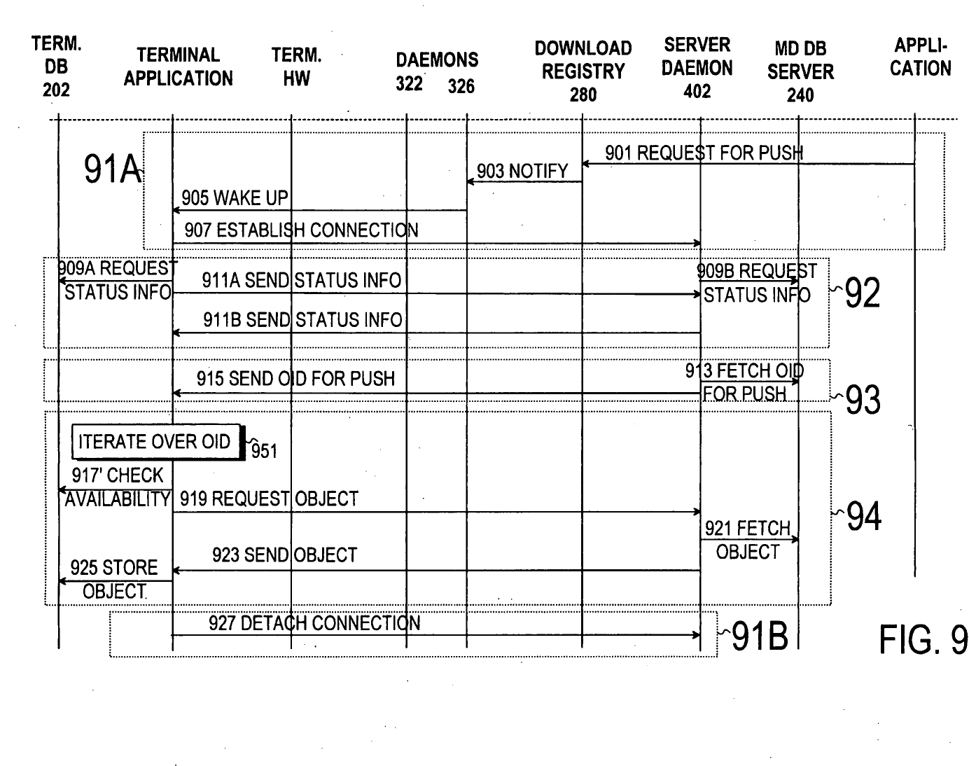

In FIG. 9 a dashed box 91A shows the start phase of the push procedure. An application (which might be 250 or 251) sends a request 901 to the download registry 280 for a push. The download registry further notifies (message 903) the terminal daemon 326, which wakes up the terminal application in question by sending message 905. The terminal application establishes a connection to the server daemon 402 by sending message 907.

Similarly, (dashed box 91B) the connection is ended by sending a message 927 which detaches the connection after the actual steps in the push process have been performed. The actual steps are described in the dashed boxes 92-94.

In a dashed box 92, the server daemon requests (message 909A) status information from the local database 202. The status information is then sent (message 911A) to the server daemon 402. The server daemon requests (message 909B) status information from the MD DB server or the remote repository. This information is then sent (message 911B) to the terminal application. In this way the terminal application and the remote repository can be synchronized.

In the dashed box 93, the server daemon 402 fetches (message 913) OIDs for a push from the MD DB server 240. The OIDs are then sent to the terminal application within a message 915.

In a dashed box 94, in step 951 the terminal application iterates over all OIDs received. It checks the availability of each object (message 917′), the apostrophe denoting the repetition of the message, because the used old-fashioned file system does not support multiple requests in a single query string. This can be corrected if the file system is adapted to correspond to the newer versions of the systems available on the market.

The objects that are not available locally are requested (message 919) from the server daemon 402. The server daemon fetches (message 921) the objects from the MD DB server 240 or directly from the remote repository. The objects retrieved are then sent to the terminal application in message 923. The objects received are then stored (message 925) in the local storage 202.

In FIG. 9 the messages and steps in the dashed boxes correspond to the push mode service delivery 554.

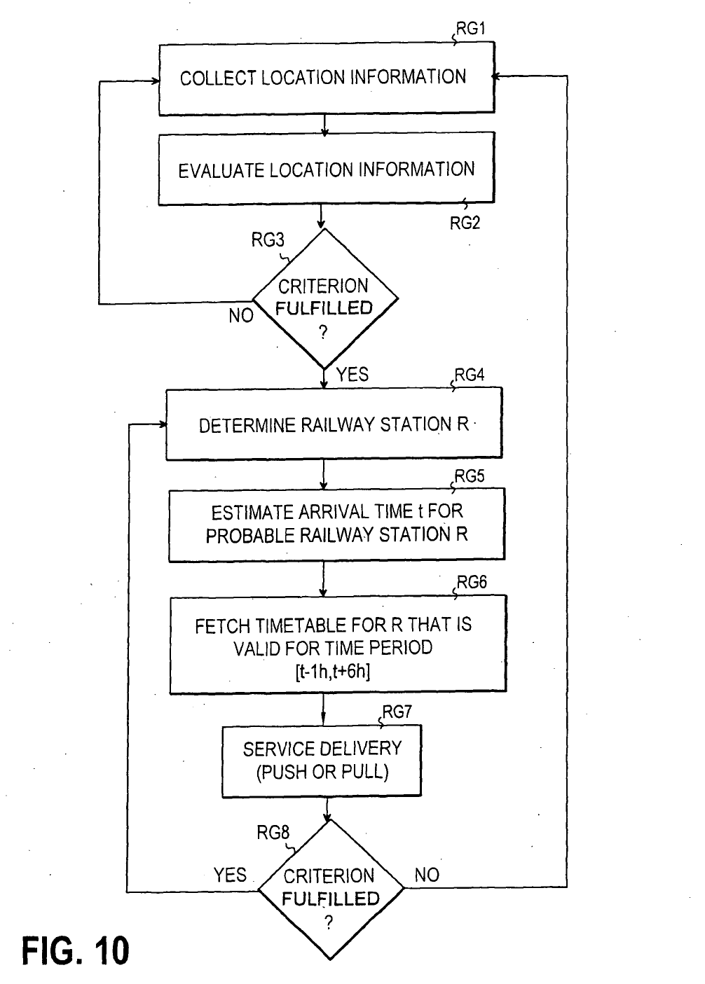

In FIG. 10 one example of access patterns and rules is described. This illustrates a fixed rule with one parameter. In step RG1 location information is collected. This information is then evaluated in an analyzer block of the system in step RG2. If it is detected that the user is heading for a railway station, there may be a criterion for providing a service when this occurs. So the criterion is checked in step RG3. If the result of the analysis shows that the user is not heading for the railway station or that there is no rule associated with such a case where the user is going to the railway station, the execution of the software returns to step RG1. Otherwise, from step RG3 the execution moves forward to step RG4. In this step the identity of the railway station is determined. For example, there may be a plurality of different railway stations close to each other, such as U-trains and S-trains commonly used in large European cities.

After the identity of the railway station has been determined, in step RG5 the arrival time t is estimated. Arrival time t is a measure for the arrival time at the expected railway station R that has been identified.

In step RG6 a timetable is fetched for R. The timetable should be valid for a time period between one hour before t and an adjustable time frame after t. The service is delivered, in push or pull mode according to user preference in step RG7.

In step RG8 it is checked whether there are also other possible stations that are probable destinations. If there are some other possible choices as well, the execution returns to step RG4, otherwise to step RG1.

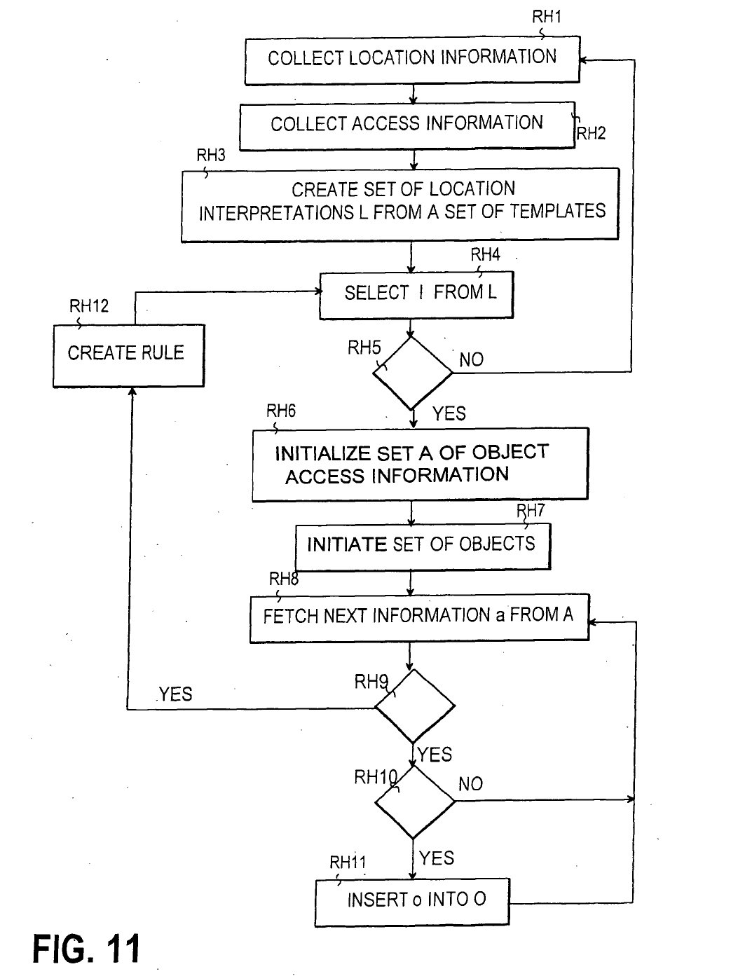

FIG. 11 is an example of a case where a metarule is used. In step RH1 location information is collected. Further, access information is collected in step RH2. In step RH3 a set of location interpretations is created. The set is denoted with L. The set is formed from templates, for example, within region A, within region B, going from A to C, outside of region D.

In step RH4 interpretation I is selected from L. If no more I is available, which is tested in step RH5, the execution returns to RH1. Otherwise, in step RH6 set A, comprised of information about object access, is initialized. This may include access information to object o when the user was in location p.

In step RH7 a set of objects O is initiated. Then in step RH8 information a is fetched from A.

In step RH9 it is tested whether a could be instantiated from A. If so, in step RH12 a rule is created providing O is not an empty set. For example, all objects o in O are fetched whenever I is true or when I is expected to become true soon. Then the program returns to RH4 in order to select another I from set L.

In step RH9, if the result was negative, in step RH10 it is checked, according to information a, whether object o has been accessed while interpretation I was true. If not, the program returns to RH8. If so, it continues to RH11. In step RH11 object o is inserted into 0.

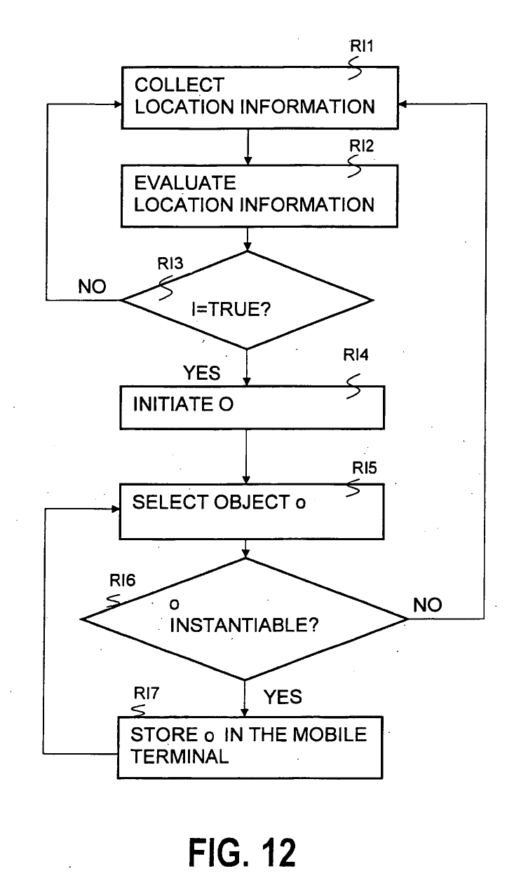

FIG. 12 shows an example of a rule created out of the metarule example above. In step RI1 location information is collected. Then in step RI2 the location information is evaluated. Test step RI3 is intended for checking if I is true or expected to become true soon. If the result is that interpretation I is not true or not likely to become true, the operation returns to step RI1. In the opposite case, in step RI4 O is initiated. Then in step RI5 object o is selected from set O, and in step RI6 it is tested whether o could be instantiated. If it could not be instantiated, the control returns to RI1. In the opposite case, in step RI7 object o is stored in the mobile terminal.

The rules and metarules may employ the detection of sequential patterns and/or association rules. They may further be based on different kinds of hierarchies.

Although the invention was described above with reference to the examples shown in the appended drawings, it is to be understood that the invention is not limited to these, but that it may be modified by those skilled in the art without departing from the scope and spirit of the invention. For example, the interpretations I described while illustrating some aspects of the present invention with FIG. 10-12 are not to be understood as being limited only to geographical locations. Similar interpretations may be constructed also for the identity of persons, the contents of information, such as digital images or email, and so forth.

1. A system for providing information for users of mobile terminals, the system comprising
a first data storage in a mobile terminal, the first data storage being adapted to store information,
at least one remote data repository connected to a telecommunications system for storing personal content including data objects and/or information extracted from said objects, whereby at least one of the repositories is assigned for the use of each mobile terminal,
a second data storage including external data, the system further comprising i) a first communicator adapted to retrieve from said remote data repository data including an object and/or information extracted from an object, ii) at least one predetermined criterion, defining a relationship between the retrieved data and said external data, iii) an analyzer, adapted to analyze whether said relationship fulfills a predetermined condition, and iv) a selector responsive to the analysis means, adapted to select data to be delivered to the mobile terminal when said condition is met, and
a second communicator responsive to the selector means adapted to deliver the selected data to the mobile terminal.

2. A system according to claim 1, the system further comprising an accessor to an external network for retrieving said external data.

3. A system according to claim 2, wherein said external network is the Internet.

4. A system according to claim 1, wherein the external data is retrieved from an external network to which the data repository is operationally connected.

5. A system according to claim 1, wherein items i), ii), iii) and iv) are located in a computer.

6. A method for providing information for mobile users, the method comprising the steps of
storing information in the mobile terminal,
connecting at least one remote data repository to the telecommunications system, storing therein information including personal content including data objects and/or information extracted from said objects, the remote data repository being provided with means for accessing the information from at least one terminal,
assigning at least one of the repositories for the use of each mobile terminal,
storing external data,
retrieving from said remote data repository data including an object and/or information extracted from an object,
reading at least one predetermined criterion, defining a relationship between the retrieved data and the external data,
analyzing whether said relationship fulfills a predetermined condition,
in response to the analyzing step, selecting data to be delivered to the mobile terminal when said condition is met, and
delivering the selected data to the mobile terminal.

7. A method according to claim 6, the method further comprising the step of accessing an external network for retrieving said external data.

8. A method according to claim 7, wherein said external network is the Internet.

9. A method according to claim 6, wherein the external data is retrieved from an external network to which the data repository is operationally connected.
